(19) United States
(12) Patent Application Publication
(10) Pub. No.: US 2005/0168046 A1
(43) Pub. Date: Aug. 4, 2005

(54) Method and apparatus for dampening vibrations in an assembly of components

(76) Inventors: Rod G. Hadi, South Lyon, MI (US); Markus Duerre, Auggen (DE)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(21) Appl. No.: 10/804,384

(22) Filed: Mar. 19, 2004

Related U.S. Application Data
(60) Provisional application No. 60/457,553, filed on Mar. 26, 2003.

(51) Int. Cl. F16F 15/03

(52) U.S. Cl. 297/463.2

(57) ABSTRACT

A vibration dampening system for a seat in a vehicle includes a seat adapted to be coupled to the vehicle. A component is coupled to the seat and has a primary function related to use of the seat. The component is decoupled from the seat in at least one direction such that the component is able to move relative to the seat, thereby having a second function related to dampening vibration in the seat.

### CROSS-REFERENCE TO RELATED APPLICATIONS

This application claims the benefit of U.S. Provisional Application No. 60/457,553, filed on Mar. 26, 2003. The disclosure of the above application is incorporated herein by reference.

### FIELD OF THE INVENTION

The present invention relates generally to an apparatus and a method for dampening vibrations induced in an assembly of components and, in particular, to an apparatus and a method for dampening vibrations induced in a vehicle seat assembly.

### BACKGROUND OF THE INVENTION

It is well known that semi-tractor trucks and other truck-type commercial vehicles tend to have a relatively stiff suspension system, whereby shock and vibration forces occasioned from traversing road bumps and the like are effectively transmitted to the driver and/or passenger in the vehicle. Likewise, when traveling at normal highway speeds and especially during acceleration and deceleration, there is a tendency for the driver or passenger to be lurched forward or rearward, depending upon the magnitude of the deceleration and acceleration vectors.

Other types of vehicles have similar vibration problems. For example pickup trucks and truck-based sport utility vehicles typically have suspension systems that are less sophisticated than passenger vehicles and can cause annoying vibrations felt by the driver and passengers. Even passenger cars that are designed to reduce or eliminate vibrations that can be felt or heard by the driver and passengers do not completely eliminate vibration problems.

To improve the comfort of the ride, it is desirable, as much as possible, to isolate the seat occupant from these types of inertial forces. There are various systems for isolating a vehicle driver or passenger from bouncing or jolting in the vertical direction. For example, in U.S. Pat. No. 3,990,668, a vehicle seat is described which incorporates a hydraulic actuator coupled in circuit with a valve whose spool is directly connected by linkages to the seat. The valve is operative to change the response of an accumulator coupled to the actuator so as to cushion the ride and to accommodate large excursions from a predetermined ride position due to major shocks. This seat assembly has no provision for cushioning or dampening fore and aft movement of the seat system.

Numerous vehicle seat suspensions are known, including those having air bag or air spring suspensions for resiliently supporting a seat in a selected position. In such suspension systems, pressurized air is delivered to or exhausted from the air bag to adjust the elevation of the seat. The use of an air bag permits upward and downward vibrations of the seat. To counteract these vibrations, shock-absorbing cylinders have been used to dampen the seat vibrations.

In one known approach, as the elevation of the seat suspension is changed by inflating or deflating the air bag, the shock absorbing cylinder has a piston supporting rod which extends or retracts, depending upon the direction in which the seat elevation is changed. In this approach, the shock absorbing cylinder is designed to be capable of extension and retraction throughout the entire range of seat elevation adjustment. In addition, these seat suspension systems are understood to use shock absorbing cylinders with pistons that, at a given seat velocity, apply a constant dampening force over the full stroke of the piston. If the dampening force were non-constant for a given seat velocity in such systems, problems would ensue. For example, in such systems a non-constant dampening force in response to a given velocity of seat movement would mean that the ride provided by the seat would vary depending upon the seat elevation.

U.S. Pat. No. 3,951,373 illustrates one form of seat suspension utilizing a shock absorbing cylinder and an air bag or air spring. In this construction, the shock absorber is understood to have a stroke which is capable of extending and retracting throughout the full range of seat height adjustment. However, in this construction, a hand knob may be operated to adjust the throw of a shaft to thereby change the effective length of the shock absorber.

U.S. Pat. No. 5,294,085 shows a seat assembly for a motor vehicle that includes an air suspension system for effectively isolating the occupant of the seat from shock, vibration and inertial forces directed along both a vertical axis and a horizontal axis. A base plate is mounted to the floor of the vehicle and supports first and second pairs of sleeve bearings on opposed sides of a box-like housing. The housing itself is attached to a pair of guide rods that cooperate with the sleeve bearings to provide fore and aft movement of the housing. Springs operating in cooperation with a first horizontally disposed air bag serve to dampen out inertial forces on the vehicle seat. The seat itself is supported atop a vertically oriented air spring and a plurality of hydraulic vibration dampeners that tend to cushion vertically directed force vectors acting upon the seat and its occupant.

U.S. Pat. No. 6,371,456 shows a seat suspension system that includes a vibration dampener adapted to operate over less than the full range over which a seat may be raised and lowered by a seat height adjuster, such as an air spring. The dampener may apply dampening forces which vary non-linearly, depending upon the extent a seat moves as a result of seat vibration. In several specific forms, the dampening mechanism is unlatched to permit relative movement of the seat and seat support mechanism relative to the dampener during seat height adjustment, with the dampener being relatched to again apply a dampening force. A mechanically simple seat leveling system may be employed to return the seat to a desired elevation in the event loading on the seat is varied, for example if a seat occupant gets up off a seat.

Although numerous seat vibration damping systems are known, a need nevertheless exists for an improved seat vibration damping system having new and non-obvious differences over known systems.

### SUMMARY OF THE INVENTION

A vibration dampening system for a seat in a vehicle includes a seat adapted to be coupled to the vehicle. A component is coupled to the seat and has a primary function related to use of the seat. The component is decoupled from the seat in at least one direction such that the component is able to move relative to the seat, thereby having a second function related to dampening vibration in the seat.

### BRIEF DESCRIPTION OF THE DRAWINGS

The above, as well as other advantages of the present invention, will become readily apparent to those skilled in the art from the following detailed description of a preferred embodiment when considered in light of the accompanying drawings in which:

FIG. 1 is a schematic view of a single degree of freedom system with a mass damper associated with a vibrating structure;

FIG. 2 is a plot of vibration amplitude versus frequency for the vibrating structure shown in FIG. 1 with and without the mass damper;

FIG. 3 is a perspective view of a vehicle seat showing vertical and horizontal axes of vibration;

FIG. 4 is a perspective view of the seat shown in FIG. 1 with an actuated side airbag as a mass damper constructed according to the principles of the present invention;

FIG. 4A is an exploded view of the airbag system shown in FIG. 4;

FIG. 5 is a perspective view of the seat shown in FIG. 1 with a heating device as a mass damper constructed according to the principles of the present invention;

FIG. 5A is a top view of the heating device shown in FIG. 5;

FIG. 6 is a perspective view of the seat shown in FIG. 1 with an adjustment device as a mass damper constructed according to the principles of the present invention; and

FIG. 6A is a partial cross-section of a connector used with the adjustment mechanism shown in FIG. 6.

### DESCRIPTION OF THE PREFERRED EMBODIMENT

The method and apparatus for damping vibrations in accordance with the present invention is described below in connection with a vehicle seat. However, this method and apparatus can be used with any assembly of two or more components where vibration is a problem. Mass dampers are used to reduce vibrations and sound pressure level within a vehicle. The result of such use is the effective elimination of unacceptable vibrations, ensuring optimum comfort to the driver and passengers.

Mass dampers help to eliminate vibrations that you can feel, hear and see. Vibrations that induce booming, droning, spattering or squeaking sounds, as well as those that cause the steering wheel, rear view mirror or interior trim to shake are carefully silenced.

The passive damper is a component that is attached to a vibrating structure. The resonant frequency of the damper is adapted to compensate for the vibrations that are generated and in turn, reduce unwanted vibrations in the structure. FIG. 1 is a schematic representation of a single-degree of freedom system wherein a structure 10 having a mass m, such as a vehicle seat, is attached to a source 11 of vibration, such as a vehicle floor. The source 11 generates a vibration force S tending to displace the structure 10 from its normal position in the direction of the arrow. The mechanical connection between the structure 10 and the source 11 will deform in response to the applied vibration force S. According to Hooke's Law, when a solid is deformed, it resists the deformation with a force proportional to the amount of deformation, provided the deformation is not too great. In FIG. 1, this resistance is represented by a spring 12 having a force constant k. Of course, the mechanical connection also has internal friction that is represented by a damper 13 having a damping constant c. The result is that the structure 10 generates a vibration force W.

A mass damper 14 having a mass m_{D} can be added to the structure 10. The resistance of the mass damper 14 to the force W is represented by a spring 15 having a force constant k_{D}. Of course, the mechanical connection of the mass damper 14 to the structure 10 also has internal friction that is represented by a damper 16 having a damping constant c_{D}. Through proper selection of the values associated with the mass, force constant and damping constant for the mass damper 14, the vibrations in the structure 10 can be significantly reduced.

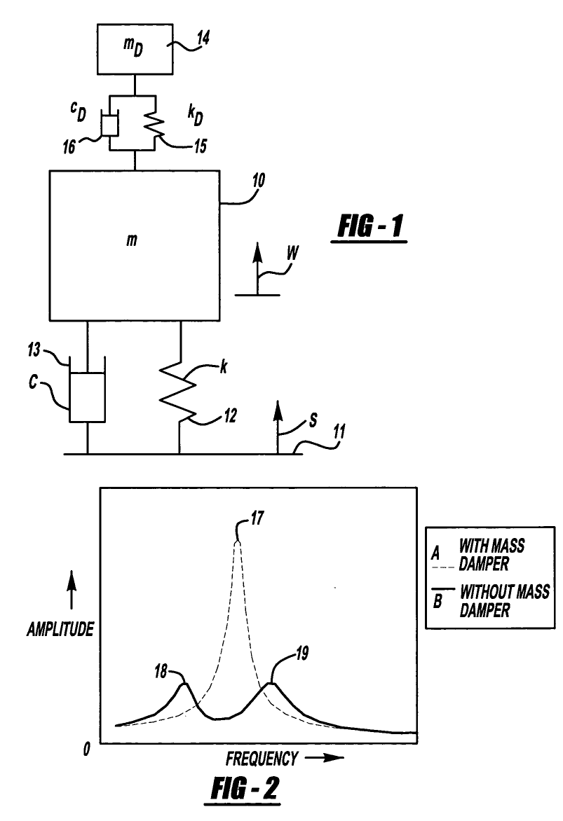

There is shown in FIG. 2, the single-degree of freedom system of FIG. 1 in the frequency domain. A curve B shows a typical amplitude peak 17 at resonant frequency for the structure 10 without the mass damper 14. By adding the mass damper 14 we can significantly reduce this peak and improve durability properties or annoying vibrations (could be sound as well). As shown by curve A, the mass damper 14, according to this example, produces two amplitude peaks 18 and 19 that are much lower in amplitude than the peak 17 without the mass damper 14. To have an optimum of effectiveness, it is essential to tune the mass damper 14 within a relatively tight tolerance and choose the right damping power.

The most crucial spots in a vehicle regarding vibrations are the ones where the driver/passenger of a car/truck has frequent contact with the vehicle. These crucial spots include the steering wheel, the pedals, the foot rest on the floor and the seats. A vibration system, such as a vehicle body with an attached seat, has several natural frequencies with vibration peaks, which could lead to a loss of comfort for the driver/passenger of that vehicle. As shown in FIG. 3, a vehicle seat 20 is subjected to the most severe vibrations along a vertical axis 21 (up and down movement) and a generally horizontal axis 22 (rocking on the base movement). These vibration peaks in the frequency domain can be reduced significantly by attaching a linear mass damper to a certain spot on the seat.

A linear mass damper is sometimes a good solution for the above mentioned vibration issue of the car seat 20. However, a growing environmental consciousness and therefore a desire for more fuel efficient vehicles have caused automobile manufacturers to strive to reduce the overall weight of the vehicles as a goal. Adding mass for vibration reduction is contradictional to the above mentioned goal and therefore should be avoided.

The present invention proposes a solution of the problem by using an existing mass as the damper mass. Current car seat designs are assemblies having several solid components like airbags, heating devices and electrical actuating motors. These components in a car/truck seat can be decoupled with an elastomeric element (rubber, MCU, combinations of these materials with fluid) and tuned to resonant frequencies to absorb annoying vibrations to an acceptable level. Of course, one has to make sure that the driver/passenger will never come in contact with one of these vibrating components.

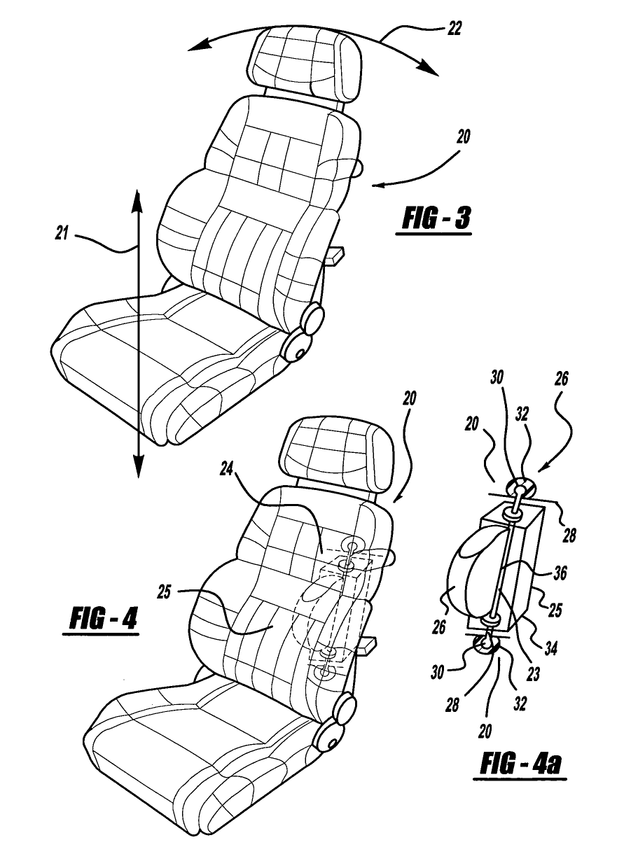

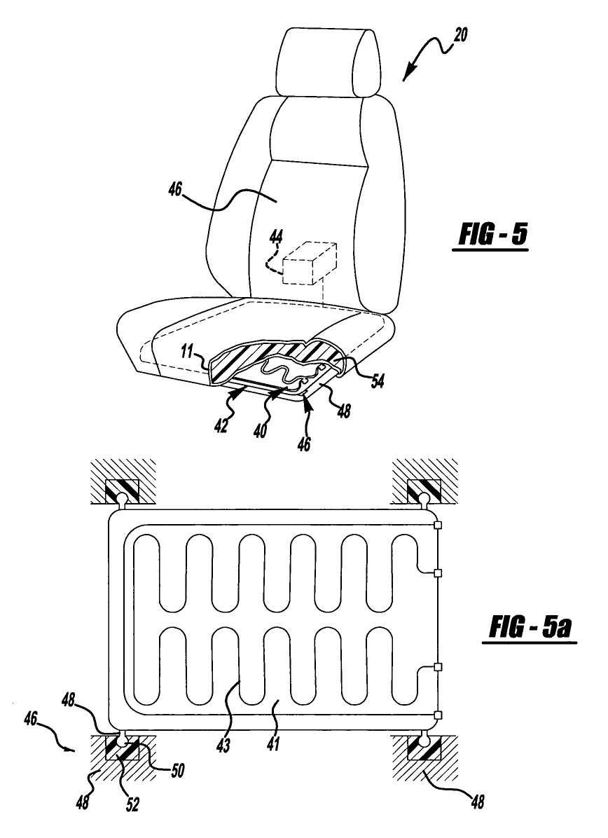

Turning now to FIGS. 4 and 4A, an airbag inflator 23 is integrated into the seat 20 as a mass damper according to a first embodiment of the present invention. The airbag inflator 23 is formed as part of an integrated seat airbag system 24. The seat airbag system 24 further includes an inflatable airbag 26 coupled to the inflator 23. The inflator 23 is “decoupled” from the seat 20 in that the inflator 23 is permitted to move relative to the seat 20 via connectors 26. This allows the inflator 23 to act as a mass dampener (m_{D} 14 in FIG. 1) within the seat 20 that dampens any vibrations transmitted thereto.

The connectors 26 may take many forms that allow the inflator 23 to move relative to the seat 20. In the particular example provided, two connectors 26 are formed on each end of the inflator 23. Each connector 26 includes a rigid shaft 28 extending out from the inflator 23. A ball 30 is formed on an end of the shaft 28. The ball 30 in turn fits within a socket 32 made of an elastomeric material coupled to the seat 20. This elastomeric material is preferably rubber or microcellular polyurethane, although any other suitable material may be employed. The ball 30 and socket 32 cooperate to “decouple” the inflator 23 from the seat 20 such that the inflator 23 may move relative to the seat 20. The connectors 26 may be tuned to provide specific dampening abilities by modifying the ball 30 and socket 32 design, or by adjusting the properties of the electrometric material of the socket 32. Moreover, the arrangement of the ball 30 and socket 32 may be reversed in that the inflator 23 may include the socket 32 and the seat 20 may include the ball 30 without departing from the scope of the present invention.

The seat airbag system 24 further includes a cage 34 coupled to the seat 20 and extending around the inflator 23. By “decoupling” the inflator 23 of the integrated seat airbag 24, the movement of the inflator 23 relative to the seat 20 must be limited during the inflation the airbag 26. The cage 34 acts to trap the “decoupled” and movable inflator 23 such that during inflation of the airbag 24, impact forces generated on the inflator 23 as the airbag 24 deploys will be supported in turn by the cage 34 as the inflator 23 contacts the cage 34. The cage 34 includes an opening 36 therein to allow the deployment of the airbag 24. The cage 34 may be a wire mesh cage or a solid container.

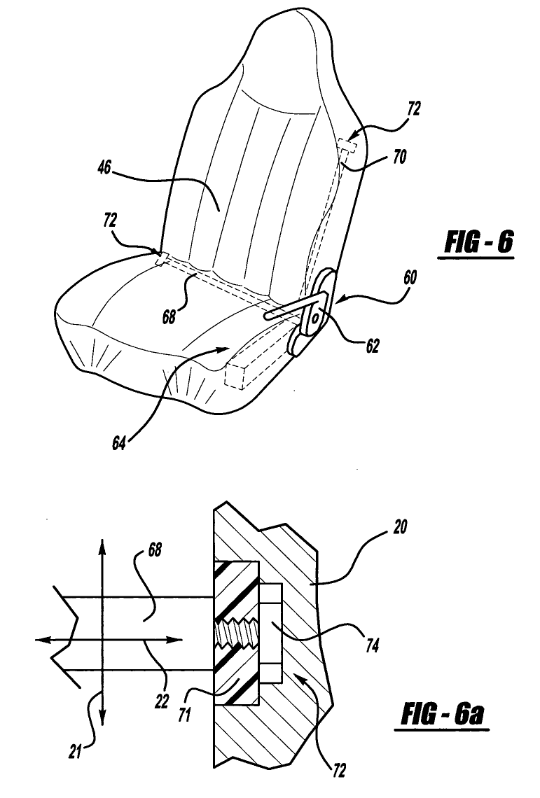

With reference to FIG. 5, a heating mat 40 is integrated with the seat 20 as a mass damper according to a second embodiment of the present invention. The heating mat 40 forms part of an integrated seat heating system 42 that further includes a controller 44 coupled to the heating mat 40. The controller 44 is illustrated schematically located within a seat back portion 46 of the seat 20.

The heating mat 40 is “decoupled” from the seat 20 by connectors 46, only one of which is shown in FIG. 5. The connectors 46 couple the heating mat 40 to a frame 48 of the seat 20 and allow the heating mat 40 to move relative to the seat 20. This allows the heating mat 40 to act as a mass dampener (m_{D} 14 in FIG. 1) within the seat 20 that dampens any vibrations transmitted thereto.

Turning to FIG. 5A, the heating mat 40 includes a body 41 with an arrangement of heating coils 43 located therein. The heating coils 43 are in turn coupled to the controller 44 (FIG. 5) and a source of electricity (not shown) to activate the heating coils 43. The connectors 46 may take many forms that allow the heating mat 40 to move relative to the seat 20. In the particular example provided, four connectors 46 are formed on each end of the corners of the heating mat 40. Each connector 46 includes a rigid shaft 48 extending out from the heating mat 40. A ball 50 is formed on an end of the shaft 48. The ball 50 in turn fits within a socket 52 made of an elastomeric material coupled to the frame 48 of the seat 20 (FIG. 5). This elastomeric material is preferably rubber or microcellular polyurethane, although any other suitable material may be employed. The ball 50 and socket 52 cooperate to “decouple” the heating mat 40 from the seat 20 such that the heating mat 40 may move relative to the seat 20. The connectors 46 may be tuned to provide specific dampening abilities by modifying the ball 50 and socket 52 design, adjusting the mass of the heating mat 40, or by adjusting the properties of the elastomeric material of the socket 32. Moreover, the arrangement of the ball 50 and socket 52 may be reversed in that the heating mat 40 may include the socket 52 and the frame 48 may include the ball 50 without departing from the scope of the present invention.

Turning back to FIG. 5, sufficient space must be provided within the seat 20 between the heating mat 40 and any cushion material 54 while still allowing heat radiating from the heating mat 40 to warm the seat 20. Moreover, the controller 44 may be arranged with elastomeric connectors similar to those illustrated in FIG. 5A to “decouple” the controller 44 from the seat 20 and allow the controller 44 to act as the mass dampener.

With reference to FIG. 6, a seat adjustment device 60 is integrated with the seat 20 as a mass damper according to a third embodiment of the present invention. In prior embodiments, the mass dampener has acted to absorb vibrations in not only the vertical axis 21 (FIG. 3) and horizontal axis 22 (FIG. 3), but in any other direction as well due to the ball and socket design of the connectors 26, 46 (FIGS. 4 and 5A, respectively). In this embodiment, various components of the seat adjustment mechanism 60 act as mass dampeners in various directions.

In the particular example provided, the seat adjustment mechanism 60 generally includes an adjustment control 62 coupled to an adjustment actuator 64. The adjustment actuator 64 is illustrated schematically as a box but is comprised of various components including shafts, levers, and gears. In the particular example provided, the adjustment actuator 64 includes at least a vertical bar 68 and a horizontal bar 70. The horizontal bar 68 and vertical bar 70 act to adjust the seat back portion 46.

By “decoupling” various components of the seat adjustment actuator 64, various dampening masses may be created. For example, each of the vertical and horizontal bars 68, 70 may be “decoupled” from the seat 20 via connectors 72. However, each bar 68, 70 is limited in movement in a particular direction in order to allow torque to be transferred therethrough such that the seat 20 may be adjusted.

With reference to FIG. 6A, one exemplary connector 72 is illustrated on an end of the horizontal bar 68. The connector 72 generally includes a fastener 74, such as a bolt, that extends through an elastomeric joint 76. This elastomeric joint 76 is preferably formed from rubber or microcellular polyurethane, although any other suitable material may be employed. The fastener 74 couples the horizontal bar 68 to the elastomeric joint 76. The horizontal bar 68 is therefore “decoupled” in the vertical direction 21 thereby dampening vertical vibrations in the seat 20. However, the horizontal bar 68 is constrained in the horizontal direction 22 and therefore absorbs no horizontal vibrations from the seat 20.

The vertical bar 70 may include connectors 72 designed substantially similar to those for the horizontal bar 68. However, the vertical bar 70 will be “decoupled” in the horizontal direction 22 and fixed in the vertical direction 21.

Various other parts of the seat adjustment actuator 60 may be “decoupled” from the seat 20 in order to act as mass dampeners. For example, components such as electrical motor seat actuators, various other shafts, levers, and gears which must be coupled to the seat 20 in certain directions to allow seat adjustment can be “decoupled” for a limited displacement. Moreover, each of these components may be tuned together to the required resonant frequency to cooperate together to act as a single mass damper.

With the above principles in mind, any solid component integrated into a car seat can be decoupled, tuned to the required resonant frequency and direction and used as a vibration absorber. In so far as the solid component includes a primary function beyond vibration absorption, no significant weight or cost will be added to the seat assembly.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A vibration dampening system for a seat in a vehicle comprising:
a seat adapted to be coupled to the vehicle; and
a component coupled to the seat and having a primary function related to use of the seat, the component decoupled from the seat in at least one direction such that the component is able to move relative to the seat thereby having a second function related to dampening vibration in the seat.

2. The vibration dampening system of claim 1, wherein the component is a heating mat and the primary function includes heating the seat.

3. The vibration dampening system of claim 2, wherein the heating mat is decoupled from the seat via connectors, the connectors comprising a rigid member coupled to an elastomeric member such that the rigid member is able to move relative to the elastomeric member.

4. The vibration dampening system of claim 3, wherein the rigid member is a ball and the elastomeric member is a socket, the ball and socket cooperating to decouple the heating mat such that the heating mat may move relative to the seat in all directions.

5. The vibration dampening system of claim 1, wherein the component is located within the seat.

6. The vibration dampening system of claim 1, wherein the component is an airbag inflator and the primary function includes inflating an airbag.

7. The vibration dampening system of claim 6, wherein the airbag inflator is decoupled from the seat via connectors, the connectors comprising a rigid member coupled to an elastomeric member such that the rigid member is able to move relative to the elastomeric member.

8. The vibration dampening system of claim 7, wherein the rigid member is a ball and the elastomeric member is a socket, the ball and socket cooperating to decouple the airbag inflator such that the airbag inflator may move relative to the seat in all directions.

9. The vibration dampening system of claim 1, wherein the component is an adjustment mechanism and the primary function includes adjusting a position of the seat.

10. The vibration dampening system of claim 9, wherein the adjustment mechanism is decoupled from the seat via connectors, the connectors comprising a rigid member coupled to an elastomeric member such that the rigid member is able to move relative to the elastomeric member.

11. The vibration dampening system of claim 1, wherein the component is decoupled from the seat in a horizontal direction relative to the seat.

12. The vibration dampening system of claim 11, further comprising a second component coupled to the seat and having a primary function related to use of the seat, the second component decoupled from the seat in a vertical direction relative to the seat such that the second component is able to move relative to the seat thereby having a second function related to dampening vibration in the seat.

13. A method for dampening vibrations in an assembly of components comprising:
selecting a component of an assembly of components, the component having a primary function;
decoupling the selected component from the assembly of components such that the component may move relative to the assembly of components thereby providing a secondary function of dampening vibrations; and
tuning the selected component to a predetermined resonant frequency and direction whereby vibrations in the assembly of components are reduced.
